(19) United States
(12) Patent Application Publication
(10) Pub. No.: US 2017/0061215 A1
(43) Pub. Date: Mar. 2, 2017

(54) CLUSTERING METHOD USING BROADCAST CONTENTS AND BROADCAST RELATED DATA AND USER TERMINAL TO PERFORM THE METHOD

(71) Applicant: ELECTRONICS AND TELECOMMUNICATIONS RESEARCH INSTITUTE, Daejeon (KR)

(72) Inventors: Jeong Woo SON, Daejeon (KR); Sun Joong KIM, Sejong (KR); Won Joo PARK, Daejeon (KR); Sang Yun LEE, Daejeon (KR); Won RYU, Seoul (KR); Sang Kwon KIM, Daejeon (KR); Seung Hee KIM, Daejeon (KR); Woo Sug JUNG, Daejeon (KR)

(73) Assignee: ELECTRONICS AND TELECOMMUNICATIONS RESEARCH INSTITUTE, Daejeon (KR)

(21) Appl. No.: 15/253,309

(22) Filed: Aug. 31, 2016

(30) Foreign Application Priority Data
Sep. 1, 2015 (KR) 10-2015-0123716
Jan. 27, 2016 (KR) 10-2016-0009764

(51) Int. Cl. G06K 9/00; H04N 21/854; H04N 21/845; G06K 9/62; H04N 21/44; H04N 21/234; G06K 9/64

(52) U.S. Cl. CPC G06K 9/00718; H04N 21/23418; H04N 21/854; G06K 9/64; G06K 9/6218; G06K 9/00758; H04N 21/44012; H04N 21/8456

(57) ABSTRACT

Provided are a clustering method using broadcast content and broadcast related data and a user terminal to perform the method, the clustering method including creating a story graph with respect to each of a plurality of scenes associated with broadcast content based on the broadcast content and broadcast related data, and creating a cluster of a scene based on the created story graph.

### CROSS-REFERENCE TO RELATED APPLICATION(S)

This application claims the priority benefit of Korean Patent Application No. 10-2015-0123716 filed on Sep. 1, 2015, and Korean Patent Application No. 10-2016-0009764 filed on Jan. 27, 2016, in the Korean Intellectual Property Office, the disclosures of which are incorporated herein by reference for all purposes.

### BACKGROUND

1. Field

One or more example embodiments of the following description relate to a clustering method using broadcast contents and broadcast related data and a user terminal to perform the method, and more particularly, to a clustering method of dividing broadcast content into story unit clusters based on a scene or a physical shot that constitutes the broadcast content and a user terminal to perform the method.

2. Description of Related Art

The growth of international Over The Top (OTT) providers, such as Netflix, Hulu, Amazon FireTV, etc., and the proliferation of domestic Internet Protocol televisions (IPTVs), cable televisions (CATVs), etc., have brought some changes to the conventional uni-directional consumption style of broadcast contents. That is, in the related art, a user may consume contents broadcast from a broadcast station at set times. In the recent times, the user may selectively consume broadcast contents based on a user demand Such a change in consumption patterns has also accelerated a change in broadcast services.

In the related art, a user, such as audience, may passively wait to view a portion of broadcast content. However, in a web service or a video on demand (VoD) service of an IPTV, the user may move to and view a part that the user desires to view. Alternatively, some contents may be divided based on a specific unit and thereby serviced. Primary techniques for realizing the service as above may include a broadcast content division technique and passive, semi-automatic, and automatic broadcast content division techniques accordingly. The divided content may be used as basic unit content of a service.

The broadcast content division method according to the related art is a method based on a physical change in content, and may divide content into scenes in consideration of a sudden change in sound information and a change on a screen. As described above, the conventional art is based on a change in a physical attribute and thus, may not connect different scenes appearing in the same storyline, such as a plurality of places in association with a single incident, a place involved with a character, etc.

Currently, the above connection issue between different scenes may be overcome in such a manner that a person directly divides broadcast content or inspects automatically divided content. However, this method may require a relatively great amount of time and cost to connect different scenes since the person directly performs division and inspection.

Accordingly, there is a need for a method that may cluster scenes of broadcast content based on a story as well as the scenes of the broadcast content.

### SUMMARY

One or more example embodiments provide a clustering method that may create a cluster based on a story unit that constitutes the broadcast content by analyzing a video, sound, and related atypical data associated with broadcast content, and a user terminal to perform the method.

One or more example embodiments also provide a clustering method that may create a cluster based on a story unit by constructing a story graph with respect to a scene based on a physical change, by measuring a consistency between story graphs, and by stratifying broadcast content, and a user terminal to perform the method.

According to an aspect of one or more example embodiments, there is provided a clustering method including receiving broadcast content and broadcast related data; determining a plurality of scenes associated with the broadcast content based on the broadcast content and the broadcast related data; creating a story graph with respect to each of the plurality of scenes; and creating a cluster of a scene based on the created story graph.

The determining may include extracting a shot from the broadcast content; determining a first scene correlation between a plurality of first scenes based on the extracted shot; determining a second scene correlation between a plurality of second scenes extracted from the broadcast related data; and creating a scene in which the first scene correlation and the second scene correlation match.

The extracting may include extracting the shot from the broadcast content based on a similarity between a plurality of frames that constitutes the broadcast content.

The creating of the scene may include creating the scene in which the first scene correlation and the second scene correlation match based on a similarity between the plurality of first scenes and the plurality of second scenes.

The creating of the story graph may include extracting a keyword from the broadcast related data; and creating a story graph that includes a node corresponding to the keyword and an edge corresponding to a correlation of the keyword.

The node and the edge may have a weight extracted from a broadcast time associated with the broadcast content.

The story graph may be represented as a matrix that indicates a change in a weight of the edge and a matrix that indicates a change in a weight of the node.

The creating of the cluster may include determining a consistency with respect to the respective story graphs of the scenes; and combining the respective story graphs of the scenes based on the determined consistency.

The determining of the consistency may include determining the consistency with respect to the respective story graphs of the scenes based on a size of a sub-graph shared by two story graphs.

The sub-graph may indicate an overlapping area in which the two story graphs overlap, and a consistency in the overlapping area may be determined on the size of the sub-graph shared by the two story graphs and a density of the shared sub-graph.

The cluster of the scene may include inconsecutive scenes according to the story graph and is represented as a single tree form.

According to an aspect of one or more example embodiments, there is provided a clustering method including receiving broadcast content and broadcast related data; extracting a shot from the broadcast content based on a similarity between a plurality of frames that constitutes the broadcast content; determining a plurality of scenes associated with the broadcast content and broadcast related data based on the extracted shot; and creating a cluster of a scene based on a consistency with respect to the respective story graphs of the scenes.

The determining may include creating a plurality of initial scenes from the extracted shot; determining a first scene correlation between the plurality of initial scenes; determining a second scene correlation between a plurality of scenes included in the broadcast related data, based on information about scenes extracted from the broadcast related data; and creating a scene in which the first scene correlation and the second scene correlation match.

The creating of the scene may include creating the scene in which the first scene correlation and the second scene correlation match based on a similarity between the plurality of initial scenes and the scenes extracted from the broadcast related data.

The creating of the cluster may include using the respective story graphs of the scenes, each story graph including a node corresponding to a keyword extracted from the broadcast related data and an edge corresponding to a correlation of the keyword.

The node and the edge may have a weight extracted from a broadcast time associated with the broadcast content.

The story graph may be represented as a matrix that indicates a change in a weight of the edge and a matrix that indicates a change in a weight of the node.

The consistency with respect to the respective story graphs of the scenes may be determined based on a size of a sub-graph shared by two story graphs.

The sub-graph may indicate an overlapping area in which the two story graphs overlap, and a consistency in the overlapping area may be determined on the size of the sub-graph shared by the two story graphs and a density of the shared sub-graph.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a configuration of a user terminal to divide broadcast content into story unit clusters according to an example embodiment;

FIG. 2 is a diagram illustrating an operation of determining a plurality of scenes associated with broadcast content according to an example embodiment;

FIG. 3 is a diagram illustrating an example of storing a plurality of scenes associated with the broadcast content according to an example embodiment;

FIG. 4 is a diagram illustrating a procedure of extracting a story graph from broadcast content according to an example embodiment;

FIGS. 5A and 5B illustrate an example of the respective story graphs of scenes according to an example embodiment;

FIG. 6 is a diagram illustrating a procedure of creating a cluster of a scene according to an example embodiment; and

FIG. 7 is a flowchart illustrating a clustering method according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

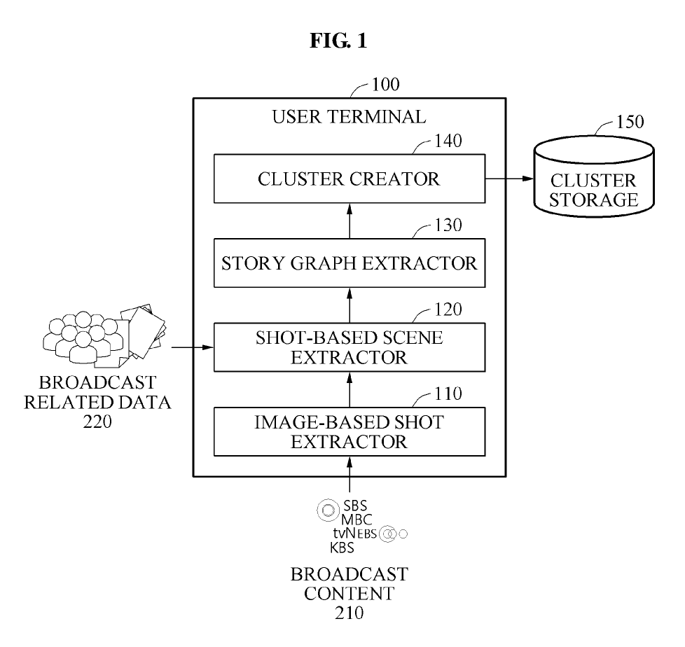

FIG. 1 is a diagram illustrating a configuration of a user terminal to divide broadcast content into story unit clusters according to an example embodiment.

Referring to FIG.1, a user terminal 100 may determine a plurality of scenes associated with broadcast content 210 based on the broadcast content 210 and broadcast related data 220, and may create a cluster of a scene based on a story graph created with respect to each of the plurality of scenes. Here, the user terminal 100 may refer to a device that displays the broadcast content 210 on a screen of the user terminal 100. Alternatively, the user terminal 100 may refer to a device that receives the broadcast content 210 from an outside and provides the received broadcast content 210 to a separate display device. Also, the user terminal 100 may include an apparatus configured to extract a semantic cluster by collecting, processing, and analyzing data associated with the input broadcast content 210. For example, the user terminal 100 may include an apparatus, such as a TV, a set-top box, a desktop, and the like, capable of displaying the broadcast content 210 through a display or a separate device.

The user terminal 100 may include an image-based shot extractor 110, a shot-based scene extractor 120, a story graph creator 130, and a cluster creator 140.

The image-based shot extractor 110 may receive the broadcast content 210 and the broadcast related data 220. The image-based shot extractor 110 may extract a shot from the broadcast content 210 based on a similarity between frames (hereinafter, also referred to as an inter-frame similarity) that constitute the broadcast content 210. The inter-frame similarity may refer to a result that is calculated based on a difference between areas, textures, colors, etc., of a background, an object, etc., that constitutes a frame. For example, the inter-frame similarity may be calculated using a color histogram extracted from a frame, a Euclidean distance, a cosine similarity, etc., based on a feature vector of a motion, and the like.

The image-based shot extractor 110 may extract the shot from the broadcast content 210 based on the inter-frame similarity. The broadcast content 210 may be represented using sequences of such extracted shots.

The broadcast related data 220 may include information about a subtitle, a script, and the like, associated with the broadcast content 210. The image-based shot extractor 110 may extract a shot from the broadcast content 210 based on the similarity between the plurality of frames that constitutes the broadcast content 210.

In detail, the image-based shot extractor 110 may extract a shot from the broadcast content 210 based on a physical change in the broadcast content 210. To this end, the image-based shot extractor 110 may extract a sound feature and an image feature from the broadcast content 210. The image-based shot extractor 110 may extract a shot corresponding to the physical change from the broadcast content 210 based on the extracted image feature.

The shot-based scene extractor 120 may determine a plurality of scenes associated with the broadcast content 210 based on the broadcast content 210 and the broadcast related data 220. The shot-based scene extractor 120 may determine the plurality of scenes associated with the broadcast content 210 based on a temporal correlation between the extracted shots and information about scenes extracted from the broadcast related data 220.

In detail, the shot-based scene extractor 120 may determine a first scene correlation between a plurality of first scenes based on the extracted shot. Here, the plurality of first scenes may indicate a plurality of initial scenes from the shot, and the shot-based scene extractor 120 may determine the first scene correlation between the plurality of initial scenes. That is, the first scene correlation may indicate a correlation between shots of the broadcast content 210.

The shot-based scene extractor 120 may determine a second scene correlation between a plurality of second scenes extracted from the broadcast related data 220. Here, the plurality of second scenes may indicate information about scenes extracted from the broadcast related data 220. The shot-based scene extractor 120 may determine a second scene correlation between scenes included in the broadcast related data 220, based on information about the extracted scenes. The shot-based scene extractor 120 may determine the plurality of scenes associated with the broadcast content 210 by creating a scene in which the first scene correlation and the second correlation maximally match. In an example in which a plurality of pieces of data indicating a correlation between the broadcast content 210 and the broadcast related data 220 are present, the maximally matching scene may indicate a scene having a highest matching relation according to the first scene correlation and the second scene correlation among the plurality of pieces of data.

The story graph extractor 130 may create a story graph with respect to each of the plurality of scenes. In detail, the story graph extractor 130 may extract a keyword from the broadcast related data 220. The story graph extractor 130 may create a story graph that includes a node corresponding to the keyword and an edge corresponding to a correlation of the keyword. Here, the node and the edge may indicate a weight extracted from a broadcast time associated with the broadcast content 210. The story graph may be represented as a matrix that indicates a change in a weight of the edge and a matrix that indicates a change in a weight of the node.

The cluster creator 140 may create a cluster of a scene based on the created story graph. Here, the cluster creator 140 may create a cluster of a scene based on a semantic consistency of the story graph, and the cluster of the scene may be a multi-layer semantic cluster that includes inconsecutive scenes according to the story graph and may be represented in a single tree form.

The clustering method according to example embodiments may receive the broadcast content 210 and the broadcast related data 220, and may create a story unit semantic cluster based on the received broadcast content 210 and the broadcast related data 220. The story-unit-based semantic cluster created through the clustering method may be stored and managed in a cluster storage 150.

The clustering method proposes a story unit division technique with respect to broadcast content. Here, the proposed story unit division may indicate dividing the broadcast content into scenes that show a plurality of story lines constituting the broadcast content. To this end, the clustering method may create a story graph that represents a story of a scene with respect to each of scenes divided based on a shot that is extracted based on a similarity between frames associated with the broadcast content, and may stratify and combine scenes based on a semantic consistency between the created story graphs. Herein, broadcast content finally divided based on a story unit may also be represented as a semantic cluster.

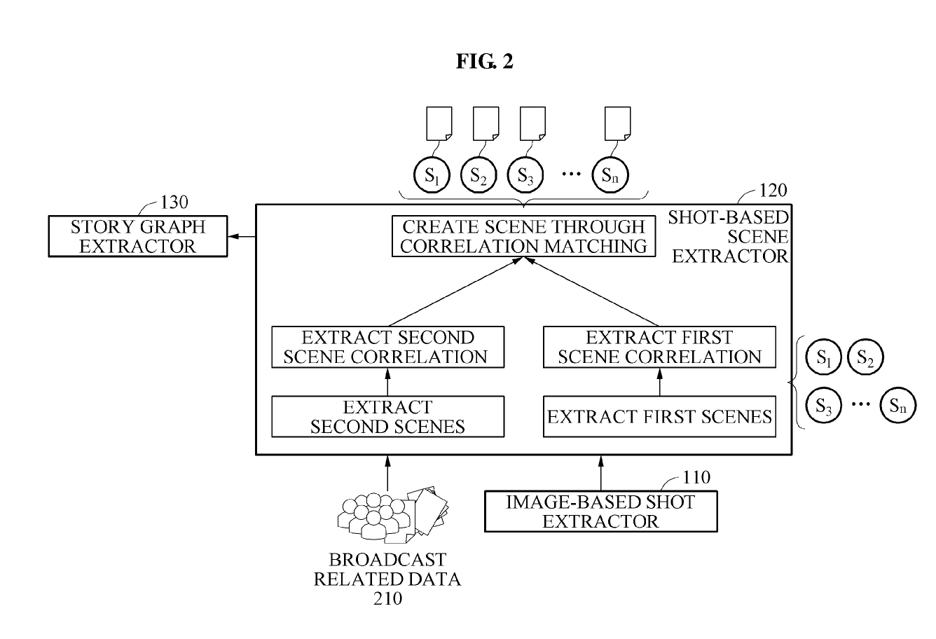

FIG. 2 is a diagram illustrating an operation of determining a plurality of scenes associated with broadcast content according to an example embodiment.

Referring to FIG. 2, the shot-based scene extractor 120 may determine a plurality of scenes associated with broadcast content based on the broadcast content and broadcast related data 220. In detail, the shot-based scene extractor 120 may extract a correlation between scenes from each of the broadcast content and the broadcast related data 220, and may determine the plurality of scenes associated with the broadcast content based on the extracted correlation.

(1) Broadcast Content

The shot-based scene extractor 120 may extract a correlation between scenes from the broadcast content. In detail, the shot-based scene extractor 120 may determine a first scene correlation between a plurality of first scenes based on a shot extracted at the image-based shot extractor 110. Here, the shot-based scene extractor 120 may create an initial scene based on a similarity between shots of the broadcast content. Here, the initial scene may indicate a scene used to determine the first scene correlation.

The shot-based scene extractor 120 may determine a first scene correlation between a plurality of initial scenes. That is, the shot-based scene extractor 120 may calculate a correlation between scenes configured by measuring the correlation between the plurality of initial scenes. The shot-based scene extractor 120 may extract a shot and then extract an image feature, a sound feature, and the like, of the broadcast content corresponding to a shot section. The shot-based scene extractor 120 may measure a correlation between shots by comparing extracted feature vectors using a conventional vector similarity calculation scheme, for example, a cosine similarity scheme, a Euclidean distance scheme, and the like.

(2) Broadcast Related Data

The shot-based scene extractor 120 may determine a second scene correlation between a plurality of second scenes by analyzing the broadcast related data 220. In detail, the shot-based scene extractor 120 may extract information associated with a plurality of scenes from the broadcast related data 220, and may extract the second scene correlation between the scenes in the broadcast related data 220 using a function of measuring a correlation between scenes based on atypical data, based on the extracted information. The shot-based scene extractor 120 may extract a correlation between scenes present in the broadcast related data 220 by analyzing the broadcast related data 220, for example, a script and a subtitle. For example, the shot-based scene extractor 120 may extract information about a correlation between scenes constituting the broadcast content by extracting and comparing subtitles present in corresponding scenes in the case of a subtitle, or by extracting and comparing words present in corresponding scenes in the case of a script.

The shot-based scene extractor 120 may create a scene in which the first scene correlation and the second scene correlation match. In detail, the shot-based scene extractor 120 may create the scene in which the first scene correlation and the second scene correlation match based on a similarity between the plurality of first scenes and the plurality of second scenes. That is, the shot-based scene extractor 120 may determine the plurality of scenes associated with the broadcast content such that 1) a direct similarity between first scenes extracted from the broadcast content and second scenes extracted from the broadcast related data 220 and 2) a correlation between measured first scenes and second scenes may match.

The shot-based scene extractor 120 may construct scene information about the plurality of scenes associated with the broadcast content through correlation matching, scenes of the broadcast content, and scenes of the broadcast related data 220. Such scene information refers to information used for correlation matching and may include the first scene correlation and the second scene correlation.

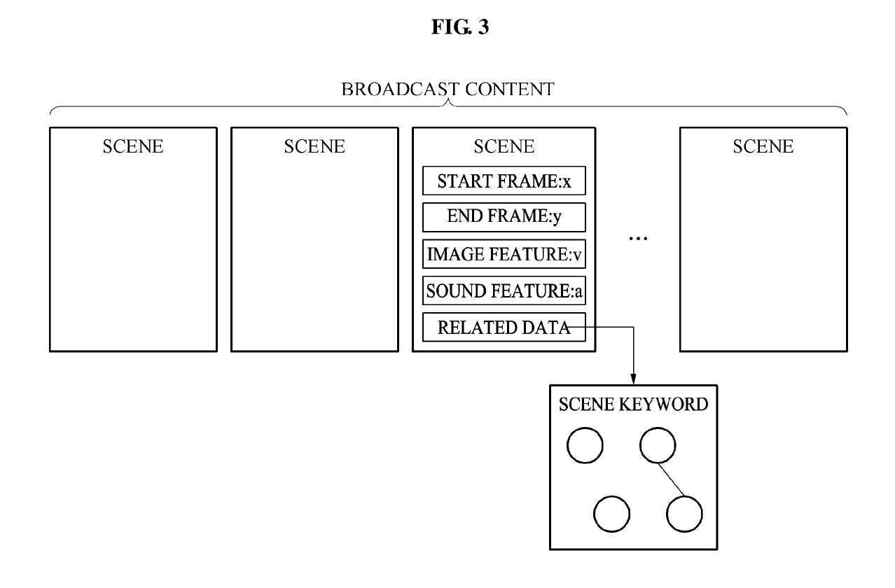

FIG. 3 is a diagram illustrating an example of storing a plurality of scenes associated with broadcast content according to an example embodiment.

Referring to FIG. 3, the shot-based scene extractor 120 may create a plurality of scenes associated with broadcast content in which a first scene correlation and a second scene correlation match based on a similarity between a plurality of first scenes and a plurality of second scenes. The shot-based scene extractor 120 may represent a data structure for storing the plurality of scenes associated with the broadcast content.

In detail, the broadcast content refers to a set that includes a plurality of scenes, which may be represented as C={S₁, S₂, S₃, . . . , Sₘ}. Here, Sᵢ denotes an i-th shot and may includes a start frame number Bᵢ and an end frame number Eᵢ. Each of the scenes may be a set that includes one or more frames. A single scene that constitutes the broadcast content may include a start frame and an end frame, and may include an image feature vector and a sound feature vector of the scene. A single scene that constitutes the broadcast content may have related data associated with the corresponding scene, and the related data may include one or more keywords.

Further, the related data may be configured using a graph, a tree, and the like, representing a relationship between keywords in order to represent a keyword extracted from the broadcast related data. Here, the related data may be used as information to convert to a story graph associated with the extracted scene.

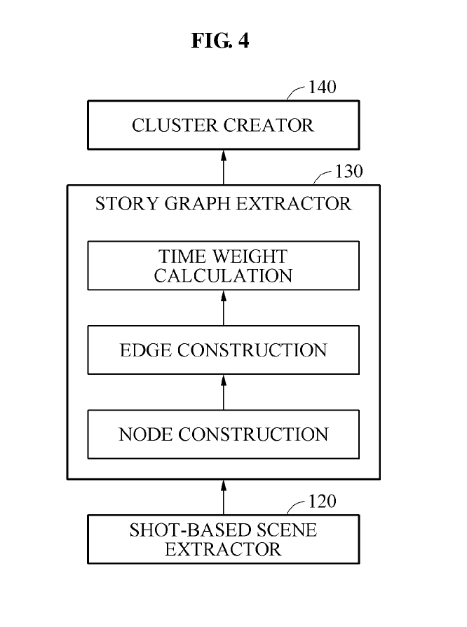

FIG. 4 is a diagram illustrating a procedure of extracting a story graph from broadcast content according to an example embodiment.

Referring to FIG. 4, the story graph extractor 130 may create a story graph with respect to each of a plurality of scenes. In detail, the story graph extractor 130 may extract a keyword from broadcast related data. Here, the keyword extracted from the broadcast related data may be configured as related data, and may be used as information to convert to a story graph associated with an extracted scene.

That is, the related data that includes the keyword extracted from the broadcast related data may be converted to a story graph with respect to each of the scenes. That is, the story graph extractor 130 may create a story graph that includes a node corresponding to the keyword and an edge corresponding to a correlation of the keyword. The story graph may be defined a weight for 1) node, edge and node, and 2) node and edge.

The node may indicate a keyword extracted from the related data and the edge may indicate a correlation between keywords. The node and the edge may have a weight extracted from a broadcast time associated with the broadcast content. The story graph including the node and the edge proposed herein may be represented as an N×N matrix. Here, N denotes a number of nodes and a value of the matrix may be acquired by expressing the correlation of the edge as a numerical number.

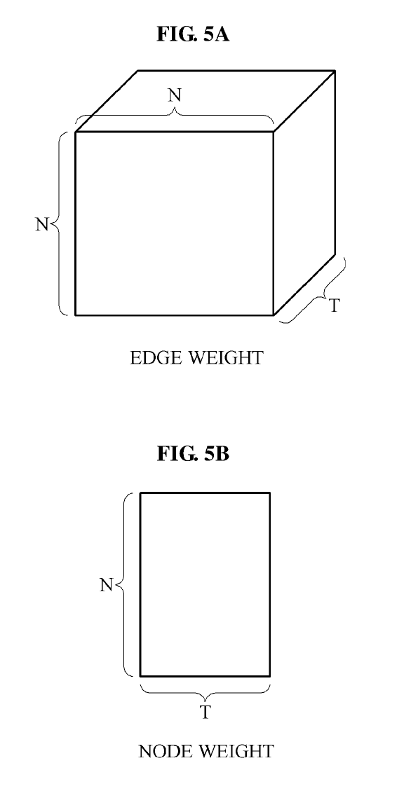

The story graph extractor 130 may represent the story graph as a matrix that indicates a change in a weight of the edge and a matrix that indicates a change in a weight of the node. The matrices may be provided as shown in FIGS. 5A and 5B, and may be stored and managed in a cluster storage. A configuration thereof will be described with reference to FIG. 5.

FIGS. 5A and 5B illustrate an example of the respective story graphs of scenes according to an example embodiment.

Referring to FIGS. 5A and 5B, the story graph extractor 130 may perform a node construction function and an edge construction function based on information about a node and an edge. The story graph extractor 130 may further add a weight according to time t to each of the node and the edge by including the node construction function and the edge construction function.

That is, the story graph extractor 130 may add the weight according to the time t to each of the node and the edge with respect to a story graph in consideration of a temporal flow associated with a scene. Accordingly, the story graph may be defined as an N×N×T matrix showing a change in a weight of the edge as shown in FIG. 5A and may be defined as an N×T matrix showing a change in a weight of the node as shown in FIG. 5B.

The story graph extractor 130 may calculate a weight according to time t using a survival function, a forgetting curve scheme, and the like, to add the weight according to the time t to each of the node and the edge.

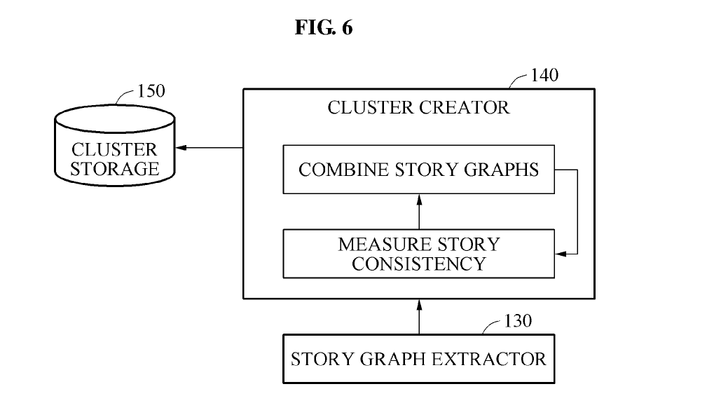

FIG. 6 is a diagram illustrating a procedure of creating a cluster of a scene according to an example embodiment.

Referring to FIG. 6, the cluster creator 140 may perform a function of measuring a consistency based on a created story graph and combining scenes. That is, the cluster creator 140 may create a cluster of a scene based on the created story graph. To this end, the cluster creator 140 may repeatedly perform a function of measuring a story consistency and a function of combining story graphs to create a semantic cluster.

In detail, the cluster creator 140 may determine a consistency with respect to the respective story graphs of scenes. Here, the cluster creator 140 may determine the consistency with respect to the respective story graphs of scenes based on a size of a sub graph shared by two story graphs. Here, a consistency for combination of story graphs may indicate a result acquired by measuring an overlapping level between the story graphs. That is, the consistency for combination of story graphs may indicate a value measured based on a size of the sub-graph shared by two graphs.

Here, the sub-graph may indicate a single largest overlapping area in overlapping between two story graphs, and a story consistency of the corresponding area may be calculated based on a corresponding overlapping graph size and a density of the sub-graph. The size may indicate an entity shared between clusters by two story graphs and the density may indicate a relationship between the shared entities. That is, the story consistency may indicate a value acquired by measuring a level of the same relationship of the same entity, for example, a character, a place, an incident, etc.

The cluster creator 140 may repeat a process of selecting a largest story graph having a largest story consistency from among all of the story graphs created with respect to the respective plurality of scenes and combining the selected story graphs, until a single top cluster remains. Accordingly, a single piece of broadcast content may be represented using a semantic cluster tree, each of nodes included in the tree may contain a correlated story, and a story may be represented in a combined graph form. If the broadcast content is configured as a single semantic cluster tree based on the semantic cluster, the result thereof may be stored in the cluster story 150 corresponding to a semantic cluster storage.

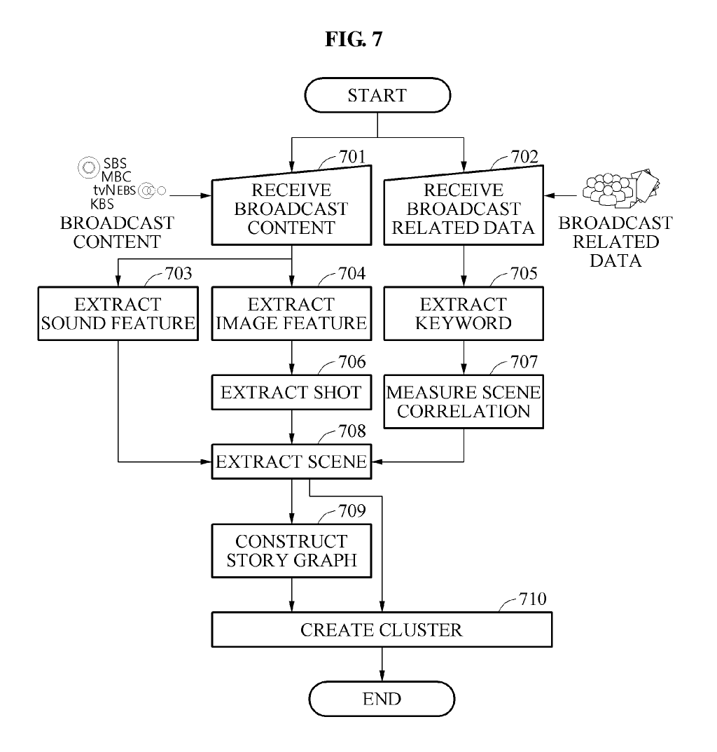

FIG. 7 is a flowchart illustrating a clustering method according to an example embodiment.

Referring to FIG. 7, in operation 701, a user terminal may receive broadcast content.

In operation 702, the user terminal may receive broadcast related data.

In operation 703, the user terminal may extract a sound feature associated with a scene from the broadcast content.

In operation 704, the user terminal may extract an image content associated with a scene from the broadcast content, and may extract a shot from the broadcast content based on the extracted image feature in operation 706. That is, the user terminal may extract the shot from the broadcast content based on a physical change in the broadcast content. The user terminal may determine a first scene correlation between a plurality of first scenes based on the extracted shot.

In operation 705, the user terminal may extract a keyword from the broadcast related data. In operation 707, the user terminal may determine a second scene correlation between a plurality of second scenes extracted based on the extracted keyword.

In operation 708, the user terminal may determine a plurality of scenes by creating a scene in which the first scene correlation and the second scene correlation match. That is, the user terminal may determine the plurality of scenes associated with the broadcast content based on the sound feature extracted from the broadcast content, the first scene correlation, and the second scene correlation extracted from the broadcast related data.

In operation 709, the user terminal may create a story graph with respect to each of the plurality of scenes. That is, the user terminal may extract a keyword from the broadcast related data, and may create a story graph that includes a node corresponding to the extracted keyword and an edge corresponding to a correlation of the keyword.

In operation 710, the user terminal may create a cluster of a scene based on the created story graph.

According to example embodiments, a clustering method and a user terminal to perform the method may reduce an amount of time and cost used to provide a broadcast service based on a scene unit by creating a story unit cluster with respect to broadcast content, and may expand a service coverage by providing the broadcast content based on a story unit.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A clustering method comprising:
receiving broadcast content and broadcast related data;
determining a plurality of scenes associated with the broadcast content based on the broadcast content and the broadcast related data;
creating a story graph with respect to each of the plurality of scenes; and
creating a cluster of a scene based on the created story graph.

2. The method of claim 1, wherein the determining comprises:
extracting a shot from the broadcast content;
determining a first scene correlation between a plurality of first scenes based on the extracted shot;
determining a second scene correlation between a plurality of second scenes extracted from the broadcast related data; and
creating a scene in which the first scene correlation and the second scene correlation match.

3. The method of claim 2, wherein the extracting comprises extracting the shot from the broadcast content based on a similarity between a plurality of frames that constitutes the broadcast content.

4. The method of claim 2, wherein the creating of the scene comprises creating the scene in which the first scene correlation and the second scene correlation match based on a similarity between the plurality of first scenes and the plurality of second scenes.

5. The method of claim 1, wherein the creating of the story graph comprises:
extracting a keyword from the broadcast related data; and
creating a story graph that includes a node corresponding to the keyword and an edge corresponding to a correlation of the keyword.

6. The method of claim 5, wherein the node and the edge have a weight extracted from a broadcast time associated with the broadcast content.

7. The method of claim 6, wherein the story graph is represented as a matrix that indicates a change in a weight of the edge and a matrix that indicates a change in a weight of the node.

8. The method of claim 1, wherein the creating of the cluster comprises:
determining a consistency with respect to the respective story graphs of the scenes; and
combining the respective story graphs of the scenes based on the determined consistency.

9. The method of claim 8, wherein the determining of the consistency comprises determining the consistency with respect to the respective story graphs of the scenes based on a size of a sub-graph shared by two story graphs.

10. The method of claim 9, wherein the sub-graph indicates an overlapping area in which the two story graphs overlap, and
a consistency in the overlapping area is determined on the size of the sub-graph shared by the two story graphs and a density of the shared sub-graph.

11. The method of claim 1, wherein the cluster of the scene includes inconsecutive scenes according to the story graph and is represented as a single tree form.

12. A clustering method comprising:
receiving broadcast content and broadcast related data;
extracting a shot from the broadcast content based on a similarity between a plurality of frames that constitutes the broadcast content;
determining a plurality of scenes associated with the broadcast content and broadcast related data based on the extracted shot; and
creating a cluster of a scene based on a consistency with respect to the respective story graphs of the scenes.

13. The method of claim 12, wherein the determining comprises:
creating a plurality of initial scenes from the extracted shot;
determining a first scene correlation between the plurality of initial scenes;
determining a second scene correlation between a plurality of scenes included in the broadcast related data, based on information about scenes extracted from the broadcast related data; and
creating a scene in which the first scene correlation and the second scene correlation match.

14. The method of claim 13, wherein the creating of the scene comprises creating the scene in which the first scene correlation and the second scene correlation match based on a similarity between the plurality of initial scenes and the scenes extracted from the broadcast related data.

15. The method of claim 12, wherein the creating of the cluster comprises using the respective story graphs of the scenes, each story graph including a node corresponding to a keyword extracted from the broadcast related data and an edge corresponding to a correlation of the keyword.

16. The method of claim 15, wherein the node and the edge have a weight extracted from a broadcast time associated with the broadcast content.

17. The method of claim 16, wherein the story graph is represented as a matrix that indicates a change in a weight of the edge and a matrix that indicates a change in a weight of the node.

18. The method of claim 12, wherein the consistency with respect to the respective story graphs of the scenes is determined based on a size of a sub-graph shared by two story graphs.

19. The method of claim 18, wherein the sub-graph indicates an overlapping area in which the two story graphs overlap, and
a consistency in the overlapping area is determined on the size of the sub-graph shared by the two story graphs and a density of the shared sub-graph.
